(19) United States
(12) Patent Application Publication
(10) Pub. No.: US 2003/0046112 A1
(43) Pub. Date: Mar. 6, 2003

(54) Method of providing medical financial information

(75) Inventors: Rabindranath Dutta, Austin, TX (US); Kumar Ravi, Cedar Park, TX (US)

Correspondence Address: Frank C. Nicholas, CARDINAL LAW GROUP, Suite 2000, 1603 Orrington Avenue, Evanston, IL, 60201, US

(73) Assignee: International Business Machines Corporation, Armonk, NY

(21) Appl. No.: 09/925,781

(22) Filed: Aug. 9, 2001

(51) Int. Cl. G06F 17/60

(52) U.S. Cl. 705/3

(57) ABSTRACT

A system and a method for providing patient medical financial information through a networked aggregate medical server are provided. Patient medical financial information may be received at the server. Patient access instructions may be received at the server. An access request for medical financial information may be received at the server from a requestor. Correspondence with the access request and the patient access instructions may be determined. The medical financial information may be formatted into a requester readable data format that may be integrated into a home accounting or tax software program. A portion of the medical financial information may be sent to the requestor based on the patient access instructions if the access request and the patient instructions correspond.

### BACKGROUND OF THE INVENTION

1. Related Applications

This application incorporates in its entirety co-pending U.S. Patent Application entitled “Method for Controlling Access to Medical Information”(AUS920010241US1), assigned to International Business Machines, Incorporated filed on______.

2. Field of Invention

The present invention generally relates to the control and access of medical financial information.

3. Description of Related Art

Presently, patients have very limited control over the dissemination of their medical financial information to healthcare providers, insurance companies, employers, credit bureaus and third party advertisers. Although law may require a release for this information, often the expiration of such releases are not honored and the information obtained may not deleted from the requesting agency's database. Further, patients' information may be used in demographic profiling, market research programs and to obtain unique identification markers by government agencies. The patient may be wholly unaware of these requests as these may be facilitated by blanket releases for information incorporated in insurance, employment and credit applications. In other cases these requests are made under the context of public security by government institutions without the patient's consent. When made aware of the release of this information, the patient may have great difficulty tracing the various requesters to withdraw the release. This is a function of the limited documentation required to request the information and the relaxation of restrictions that would require additional input from the patient. It would be desirable to have a method whereby patients could control access to their medical financial information by third parties.

Another shortfall of the present means for managing patient medical financial information is that it comprises many different medical charges from various healthcare providers, configured in numerous formats and coded entries that must be associated, catalogued and stored. The volume and complexity may lead to errors in the providing timely payment to healthcare providers, incorrect billing of the patient, incorrectly limiting access to medical services to a patient and a potential to misdirect medical charges to the wrong patient. Presently a patient is afforded no means to review and annotate the database to reflect apparent discrepancies. Typically, the only means available for annotating the database is by informing the healthcare insurer, who may or may not coordinate this information to other parties involved with the patient, such as, healthcare providers, pharmacists, therapists, etc. This poses a potential for the record being inaccurate and bearing the potential for billing inaccuracies.

Another shortcoming of the present method of managing patient medical financials is that the patient is seldom permitted to review the healthcare provider's charges and verify it until the insurer has considered the matter. Furthermore, responses formulated by the patient as to billing discrepancies and treatments provided are not easily incorporated into the medical financial record, and require third party input by the insurer. This lack of information most directly negatively impacts the patient's consideration when evaluating medical options at his disposal under the patient's insurance plan. It would be advantageous to have a system whereby the patient could verify and annotate his or her medical financial records.

The medical financial information is seldom usable to the patient in distinguishing the nature of the medical service rendered and the level of coverage afforded the patient due to the various billing code structures employed by the insurers and healthcare providers. Without reformatting the data it is difficult for the patient to review and verify the information. The healthcare providers and insurance investigators almost exclusively control the verification process. This manner of review typically occurs when the insurer has noted a significant number of anomalies. The patient in many cases has been overcharged or fraudulent charges have been paid. Redress typically, involves expensive and burdensome litigation to effect recovery of any portion of the misdirected funds. It would be advantageous to have a system that overcomes this disadvantage.

The need to secure the medical financial information of a patient continues to be a paramount concern. Several systems exist that provide security of the medical data employing various cryptographic mechanisms to prevent the unauthorized access to data however; these do not allow the patient to modify a requester's access. Some systems further restrict direct access to the patient of his or her own medical data and require that access be afforded via a third party. It would be desirable to have a system that overcomes the above and other disadvantages.

### SUMMARY OF THE INVENTION

The present invention relates to a method for a networked aggregate medical server to provide patient medical financial information. Various aspects of the invention are novel, non-obvious and provide various advantages. While the actual nature of the present invention covered herein can only be determined with reference to the claims appended hereto, certain features, which are characteristic of the embodiments disclosed herein, are briefly described as follows.

One aspect of the invention provides a method to provide patient medical financial information through a networked connection. The patient medical financial information may be received at an aggregate medical server. The patient access instructions may be received at the aggregate medical server. An access request may be received from a requester at the aggregate medical server. The correspondence between the access request and the patient access instructions may be determined. The patient medical financial information may be formatted into a requestor readable data format. Based on the patient access instructions and the access request a portion of the patient medical financial information may be sent to the requestor if the patient access instructions correspond with the access request.

Another aspect of the invention provides for a computer usable medium, generally an aggregate medical server storing a program to provide patient medical financial information through a networked connection. Computer readable code is provided to receive patient medical financial information, receive patient access instructions, receive an access request from a requester, determine whether the access request corresponds with the patient access instructions, format the patient medical financial information into a requester readable data format and send a portion of the patient medical financial information to the requestor based upon correspondence between the patient access instructions and access request.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a diagram of one embodiment of a system for a networked aggregate medical server to provide patient medical financial information, in accordance with the invention;

FIG. 2A is a block diagram illustrating one embodiment of a networked aggregate medical server to provide patient medical financial information, in accordance with the invention;

FIG. 2B, FIG. 2C, FIG. 2D and FIG. 2E are examples of database tables for the operation of one embodiment of the networked aggregate medical server shown in FIG. 2A to provide patient medical financial information, in accordance with the invention;

FIG. 2F is an illustration of one embodiment of a patient readable data format of patient medical financial information, in accordance with the invention; and

FIG. 3A and FIG. 3B are flowcharts of one embodiment of a routine to provide patient medical financial information, in accordance with the invention.

### DETAILED DESCRIPTION OF THE PRESENTLY PREFERRED EMBODIMENTS

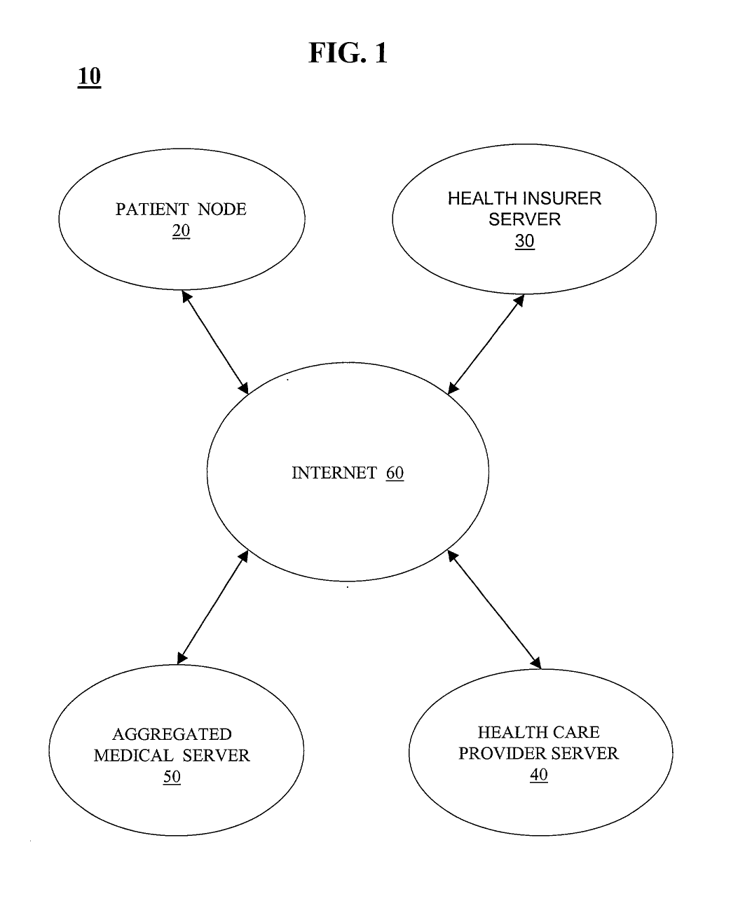

FIG. 1 illustrates one embodiment of a system for a networked aggregate medical server to provide patient medical financial information, in accordance with the invention.

Referring to FIG. 1 one embodiment of a system for a networked aggregate medical server restricting access to patient medical financial information is generally shown at numeral 10. The patient medical financial information may for example be comprised of coded itemized charges for laboratory services, diagnostic test procedures, dental services, physician charges, pharmacy charges, hospital charges, patient identification data and insurance provider data. The network aggregate medical server system 10 may include a patient node 20, a health insurer node 30, a health care provider server 40, an aggregated medical server 50 and Internet 60. In another embodiment the system 10 may be any of a local area network, an intranet or a virtual private network. The system 10 may receive patient instructions to restrict access to the patient medical financial information via the Internet 60 from the patient node 20. The patient node 20 may utilize any personal computer, personal digital assistant, digital telephone or any device capable of communicating over the Internet 60 known in the art to generate instructions to restrict access to patient medical financial information. The patient node 20 may be operably connected to the Internet 60. The Internet 60 may rout any number of digital signals to any of a plurality of server site addresses via various telecommunication means over the World Wide Web. Any commercially available Internet Service Provider, ISP known in the art providing access to the World Wide Web, may access the Internet 60. The Internet 60 may receive and direct the patient instructions to restrict access to patient medical financial information to the aggregated medical server 50.

In another embodiment the system 10 may receive requests for patient medical financial information from the patient via the Internet 60 from the patient node 20. The patient node 20 may be any personal computer, personal digital assistant, digital telephone or any device capable of communicating over the Internet 60 known in the art to receive requests for patient medical financial information. The patient node 20 may be operably connected to the Internet 60. The Internet 60 for receiving and directing requests for patient medical financial information to the aggregated medical server 50. The Internet 60 subsequently, may receive and direct patient medical financial information to the patient node 20 from the aggregated medical server 50.

The system 10 may receive requests for patient medical financial information from various healthcare insurers, employers and other interested third parties via the Internet 60 from the health insurer server 30. The health insurer server 30 may be any computer server capable of routing digital signals to any other computer via the Internet 60, intranet, local area network or any other network using any telecommunications means, known in the art to send and receive requests for patient information. The health insurer server 30 may be operably connected to the Internet 60. The Internet 60 may receive and direct requests for patient medical financial information to the aggregated medical server 50. The Internet 60 subsequently, may receive and direct patient medical financial information to the health insurer server 30 from the aggregated medical server 50.

The system 10 may receive requests for patient medical financial information from the various healthcare providers and treatment centers via the Internet 60 from the healthcare provider server 40. The healthcare provider server 40 may be any computer server capable of routing digital signals to any other computer via the Internet 60, intranet, local area network or any other network using various telecommunications means, known in the art to transmit and receive requests for patient account information. The healthcare provider server 40 may be operably connected to the Internet 60. The Internet 60 may receive and direct requests for patient medical financial information to the aggregated medical server 50. The Internet 60 subsequently, may receive and direct patient medical financial information to the healthcare provider server 40 from the aggregated medical server 50.

The system 10 may process requests for patient medical financial information and transmit patient medical financial information from a medical financial information clearinghouse to any requester that may be permitted to receive the data via the Internet 60 from the aggregated medical server 50 to any of the patient node 20, the healthcare insurer server 30 or the healthcare provider server 40. The aggregated medical server 50 may be any commercially available computer server capable of providing secure transactions over the Internet 60 via any hardware and/or software methods known in the art. The aggregated medical server 50 may be operably connected to the Internet 60. In another embodiment, the system 10 may transmit the medical financial information in a patient readable format for example Quicken®, Microsoft Money® or any other accounting or tax software programs whereby the patient could receive medical financial information in a preferred format to review insurance coverage for medical services. The medical financial data may then be stored in the desired format locally at the patient node 20, at the aggregated medical server 50 or any other server designated for storage of the patient medical financial information. The program may determine the co-payment amount, outstanding policy deductible, tax liability, patient amount due, remaining policy benefit or other desired information. In another embodiment, the software program may consolidate the patient medical financial data and may determine a tax deduction available to the patient based on an insurance plan deductible, a patient tax bracket, a classification of medical charge and an out-of-pocket expense based upon receiving patient medical financial information in a patient readable format. The software may reside in whole or in part on any of the aggregate medical server 50, health insurer server 30, healthcare provider server 40 or any secure third party server designated for reconciling patient medical financial information. In another embodiment, the program and the patient account data may reside on a third party network server, which may provide secure access to the patient medical financial information. The patient may also facilitate electronic payment of any medical charge using the account information and any home accounting or tax software, or electronic payment system. In another embodiment the patient may provide input to the insurer to encourage an audit of fraudulent healthcare providers' charges. This aspect of the invention may aid in reducing the cost to the healthcare insurer and stabilizing insurance premiums to the patient.

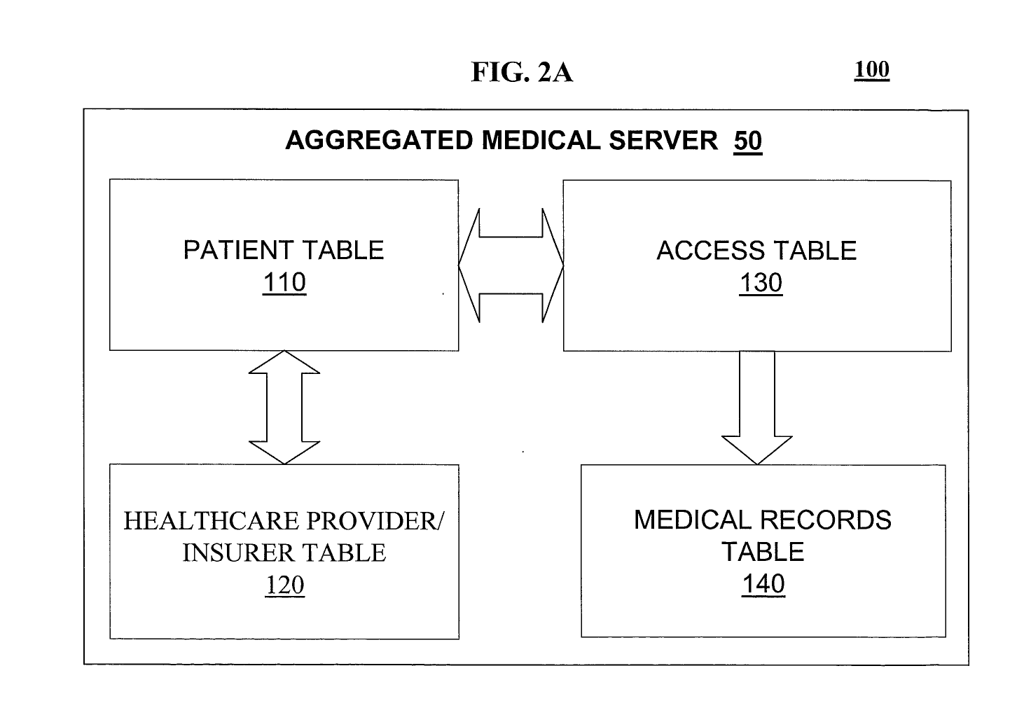

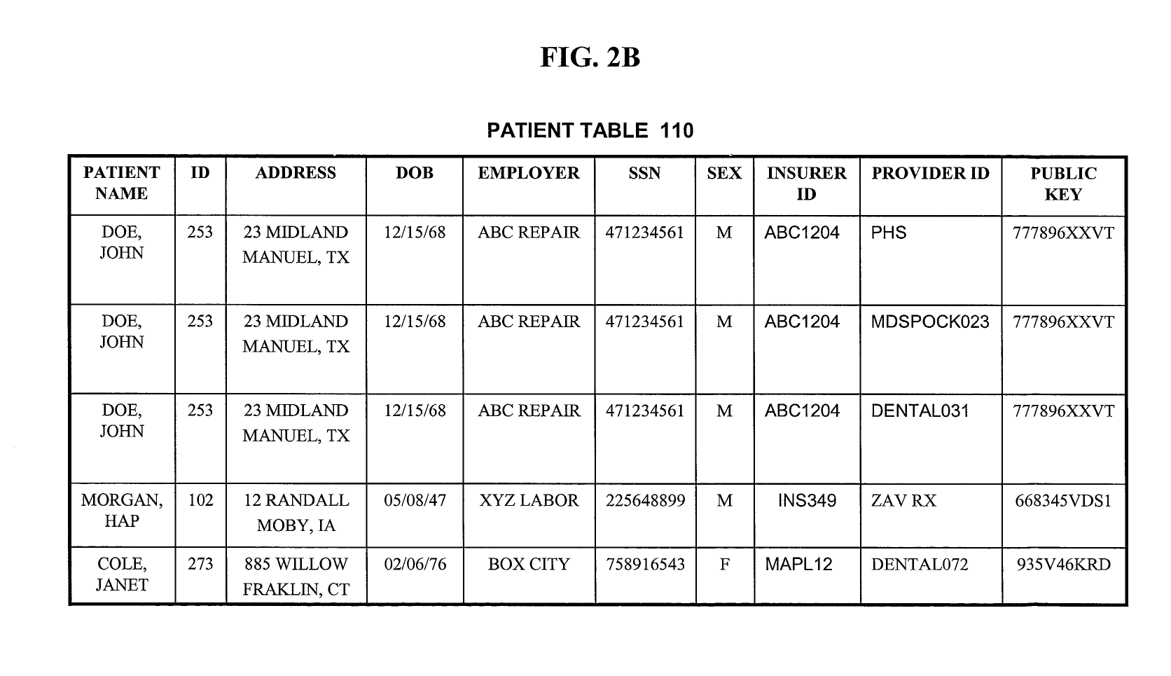

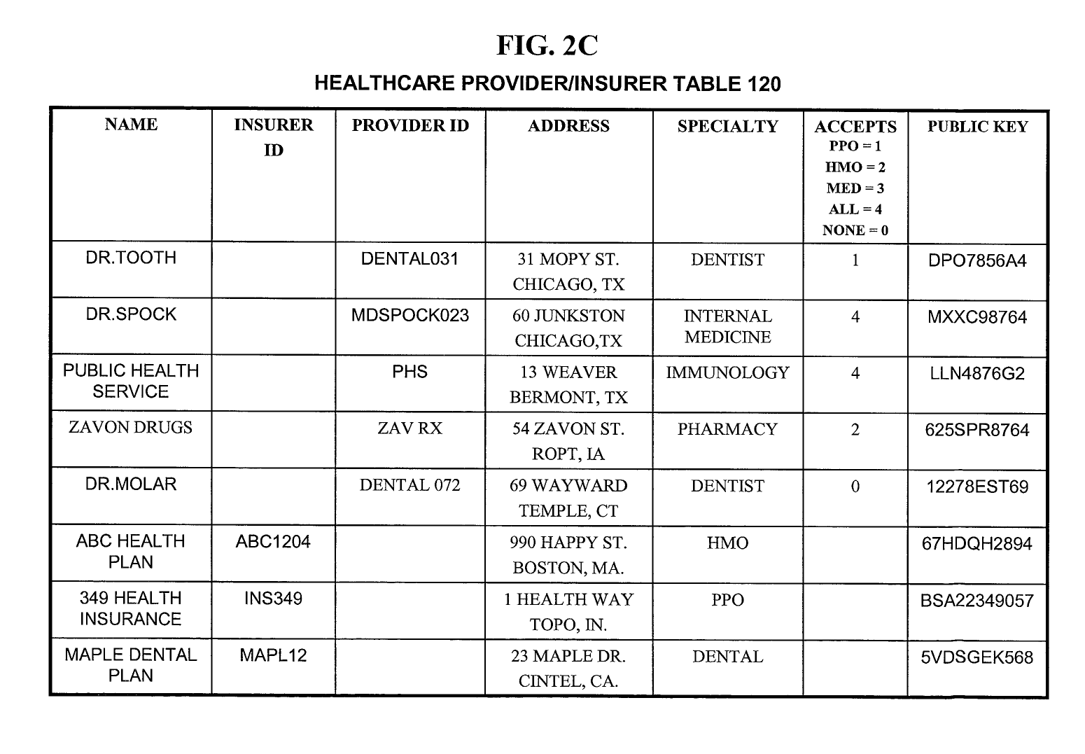

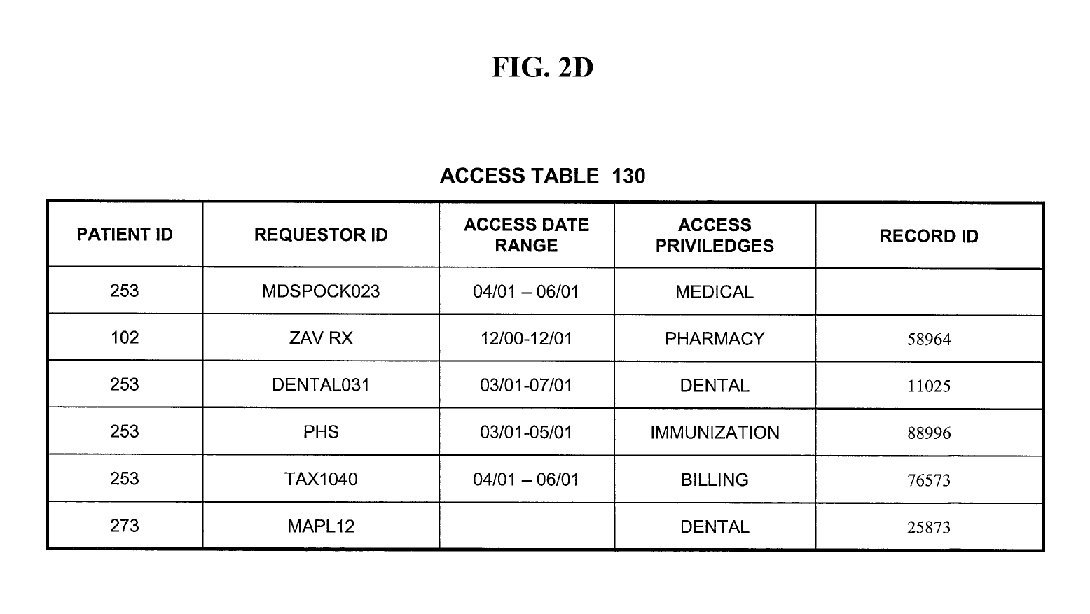

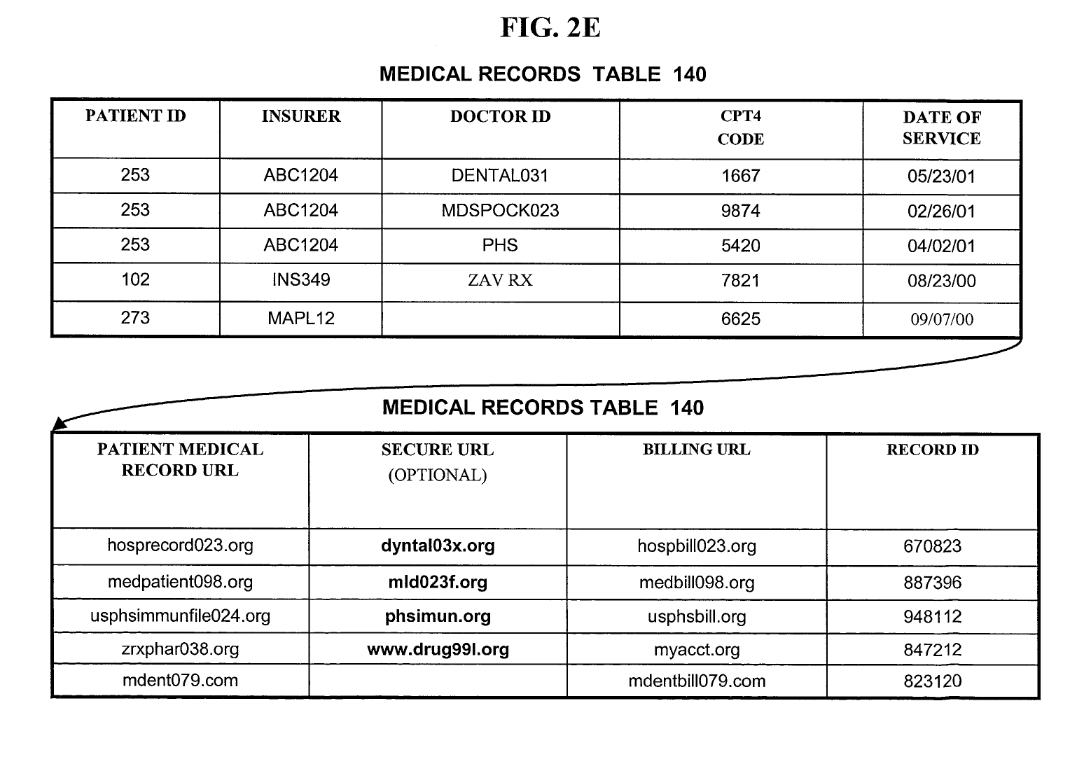

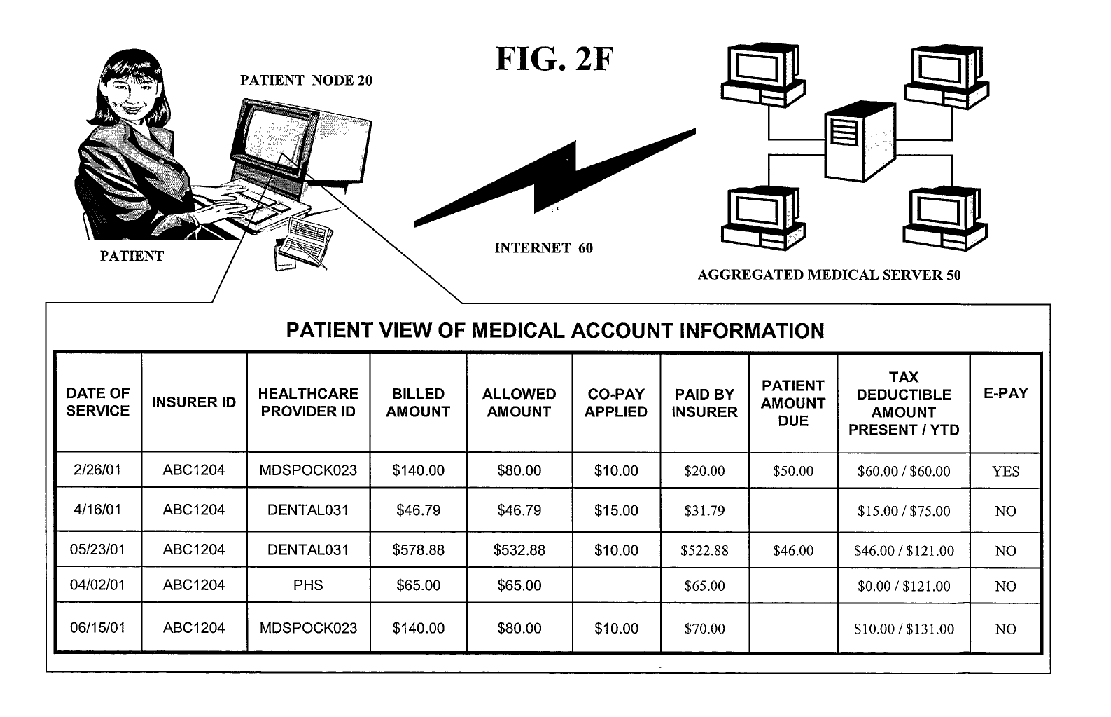

FIG. 2A illustrates one embodiment of an operating system for a networked aggregate medical server to provide patient medical financial information, in accordance with the invention.

FIG. 2B, FIG. 2C, FIG. 2D and FIG. 2E illustrate database tables for the operation of one embodiment of the networked aggregate medical server shown in FIG. 2A to provide patient medical financial information, in accordance with the invention.

FIG. 2F illustrates one embodiment of a patient readable data format of patient medical financial information, in accordance with the invention.

Referring to FIG. 2A one embodiment of a system for an aggregate medical server 50 for restricting access to patient medical information is generally shown at numeral 100. The aggregate medical server operating system 100 may include a patient table 110 shown in FIG. 2B, a healthcare provider/insurer table 120 shown in FIG. 2C, an access table 130 shown in FIG. 2D and a medical records table 140 shown in FIG. 2E stored on an aggregated medical server 50. In another embodiment, the aggregated medical server 50 may store tables for patient access instructions, healthcare provider access, healthcare insurance access, patient account data and medical information. The aggregated medical server 50 may secure transactional data using extensible mark-up language, (XML), public key cryptography to secure medical financial information. In another embodiment the tables may contain data objects that may be used to associate medical records, patient information, billing data, healthcare provider data, server site addresses, physical location identification data for permanent hardcopy files or other elements as required to facilitate association written in extensible mark-up language, (XML) as further described in Extensible Mark-up Language 1.0 W3C Recommendation Oct. 6, 2000 [http://www.w3.org/TR/REC-xml]. These data objects may be well formed parsed entities containing root entities, which may be composed of properly nested declarations, elements, comments, character references, processing instructions and references to other entities. These entities may be accessed by any combination of public key, digital signature, password or other cryptographic means known in the art which satisfy any validity constraint, well formedness constraint or reference requirement nested in the processing instructions. In another embodiment, the entity may be further encrypted and secured by converting the entity by any encryption algorithm in combination with any public key, digital signature, password or other cryptographic means known in the art to render a non-valid entity incapable of being read by any validating or non-validating XML processors. An example of the XML entities for Medical Financial Information is shown below in Table 1.0.

TABLE 1.0
Example of XML Entities
<MEDICAL FINANCIAL INFORMATION>

| <Patient Name> | </Patient Name> |
|---|---|
| <Social Security Number> | </Social Security Number> |
| <Date of Service> | </Date of Service> |
| <Provider ID> | </Provider ID> |
| <Insurance Company> | </Insurance Company> |
| <Co-Payment> | </Co-Payment> |
| <Co-Payment Mode> | </Co-Payment Mode> |
| <CPT4 Code> | </CPT4 Code> |
| <Billed Amount> | </Billed Amount> |
| <Allowed Amount> | </Allowed Amount> |
| <Insurance Payment> | </Insurance Payment> |
| <Insurance Payment Date> | </Insurance Payment Date> |
| | </Medical Financial Information> |

The aggregated medical server 50 may receive patient instructions to restrict patient medical financial information via the Internet 60 from the patient node 20. The aggregate medical server 50 may store the patient instructions to restrict patient medical financial information in an access table 130. The aggregate medical server 50 may receive requests for patient medical financial information and accounting data via the Internet 60 from the patient node 20, the health insurer server 30 and the healthcare provider server 40. The aggregate medical server 50 may store the healthcare provider and health insurer data in a healthcare provider/health insurer table 120. In another embodiment, the aggregate medical server 50 may have a separate healthcare provider table and a health insurer table. In another embodiment, the aggregated medical server 50 may permit healthcare providers and health insurance providers to input data into the patient medical records table 140 via the access table 130. Where correlation exists between the patient data and access instructions stored in patient table 110, the healthcare provider/health insurer table 120 and the access table 130 the aggregate medical server 50 may permit access to the medical records table 140 using any matching techniques known in the art for assembling correlation tables. Subsequently, the aggregate medical server 50 may obtain authentication of a requestor's public key from a third party certificate authority such as VeriSigne®. The medical server 50 may then format the patient medical financial information into a patient readable data format. In another embodiment, the aggregate medical server 50 may use the public key to provide access to a portion of the patient medical table 140 to the requesting party by passing decryption data and protocols to the patient medical records table 140 by any means known in the art. Subsequently, the aggregate medical server 50 may transmit the encrypted patient medical financial information to the patient, the healthcare provider, or the health insurer or any other requester the patient may grant access via the Internet 60 to the patient node 20, to the health insurer server 30 or the healthcare provider server 40.

In another embodiment, the aggregate medical server 50 may receive instructions from the patient to annotate a portion of the patient medical financial information using XML to make comments regarding veracity of the data, treatment received, payments made and discounts applied by the insurer via the Internet 60 from the patient node 20. The aggregate medical server 50 may further transmit patient comments to designated healthcare providers and insurers based on the comments made in the patient medical record where the medical server 50 transmits the comments via the Internet 60 to the healthcare insurer 30 and the healthcare provider server 40.

An example of one embodiment is generally shown in the patient access table 110 where John Doe, a patient may be provided an identification number 253 associated with other unique patient identifiers such as social security number, date of birth, address or other data that may be used for this purpose. The patient, John Doe identified as patient ID 253 in this example, may have a public key 777896XXVT obtained from any third party certificate authority (i.e. VeriSign®), known in the art that issues digital certificates, however, a password or digital signature may be substituted. The patient subsequent to obtaining a public key may then select which healthcare providers, insurers and other third parties may have access to his medical financial information, the length of authorization and level of access. One embodiment of these inputs is illustrated in the access table 130. In table 130 John Doe, patient ID 253 has provided access limited to his medical records to MDSPOCK023 for the period of 4/01 to 6/01. The access table 130 may also show that patient 253 has also granted billing access to TAX1040 and restricted access to DENTAL031 and PHS each having different access date ranges. In another embodiment, the access table 130 may restrict the selection of patient financial information using the record ID in lieu of the access date range. The access table 130 in this embodiment may give precedence to the record ID when both the record ID and access date range are both available. Any of the healthcare providers and insurers identified including patient 253 may review his medical financial information in accordance with the restrictions expressed in the access table 130. For example Mr. Doe may permit Tax Accountants, identified as TAX1040, to file an income tax return itemizing medical and dental expenses. Tax Accountants has determined that dental billing information from Dr. Tooth is required for Mr. Doe's tax return. Subsequently, the medical server 50 may correlate the request against the healthcare provider/insurer table 120 where Dr. Tooth may be identified as DENTAL031 and may subsequently be correlated against the access table 130. Upon corresponding Dr. Tooth's ID, with the access instructions provided by the patient in access table 130, Tax Accountants may be granted to the medical records table 140. The medical records table 140 may then only provide the patient's dental account records for Dr. Tooth the period from 4/01 to 6/01 and subsequently, may transmit these records in a encrypted state to the requester. The patient dental account information may then be formatted into a requestor readable data format. Subsequently an URL containing the address of the encrypted files is may then be generated and transmitted to the requestor. In one embodiment the URL may be secure. In this example, Tax Accountant's request may be limited to Dr. Tooth's dental account records for Mr. Doe in order to obtain medical financial information regarding another healthcare provider Tax Accountants may submit an additional access request to the aggregated medical server 50. Subsequent to receiving the URL the patient may access the requested medical data using any home accounting or tax software such as Quicken©, TurboTax©, MS Money©, etc. The patient may review the output as a billing profile shown in FIG. 2F that may consolidate charges to allow the patient to determine available insurance, deductible, healthcare provider charges and tax-deductible issues. In another embodiment, a software agent may be provided to perform the functions of; reconciling payments and credits from insurers and a patient, comparing the payments against a patient insurance plan, reconciling a patient medical account with a patient medical charge, a patient payment and a patient insurance plan and calculating tax credits and tax deductions based on the patient insurance plan, a patient medical insurance premium and patient payments and credits. In another embodiment, the software agent may reside on any of the patient PC, the aggregate medical server or any secure third party server for processing patient medical financial information. In another embodiment, the software agent may be embedded in any home accounting or tax software. In another embodiment, the patient may reconcile a medical charge using a home accounting/tax software. The patient may also calculate tax credits and deductions using the software. The patient subsequent to review may store the medical financial information on the patient node 20 or on a secure third party network server. In another embodiment, the patient may facilitate payment of the medical charges via the Internet 60 to the healthcare provider where the patient node 20 transmits payment via the Internet 60 to the healthcare provider server 40. In another embodiment, the software may reside on the medical server 50 or any secure third party server.

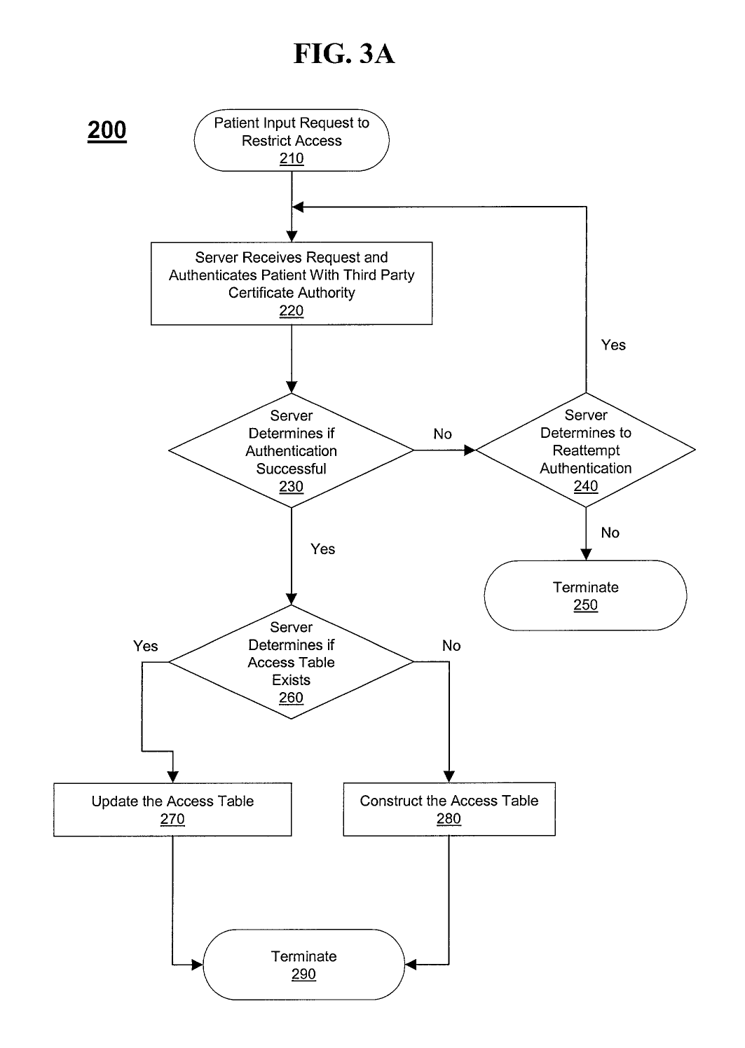

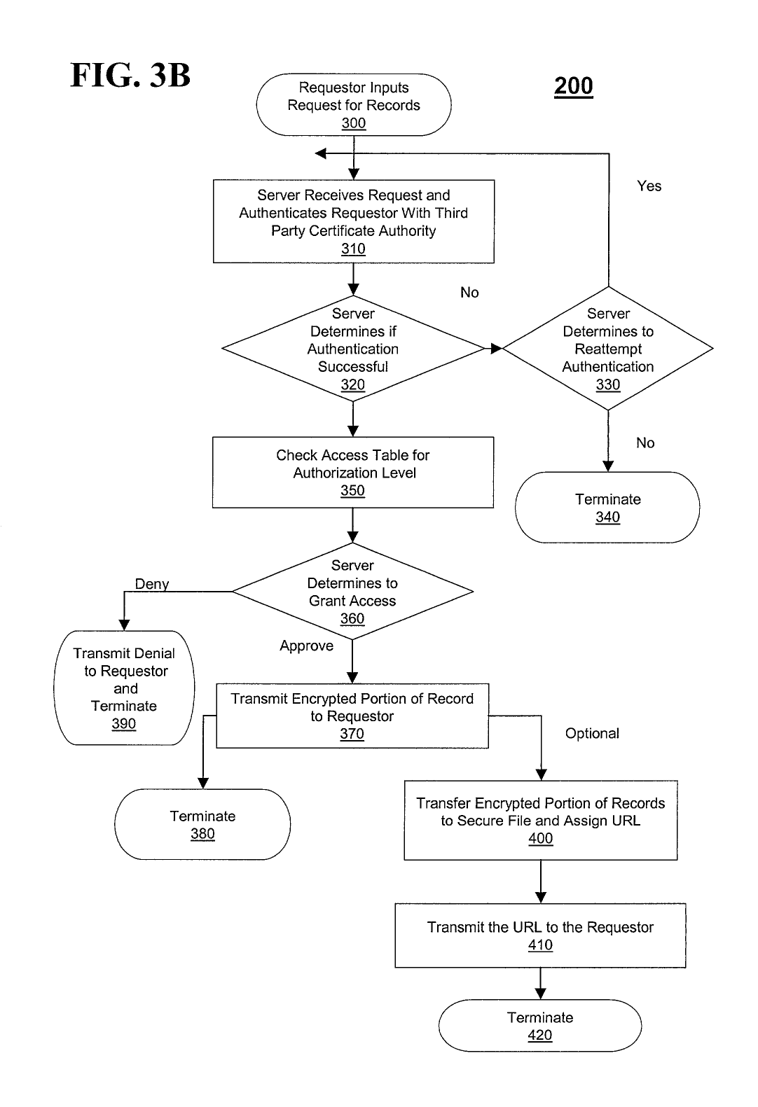

FIG. 3A and FIG. 3B illustrates one embodiment of a routine for a networked aggregate medical server for restricting access to patient medical financial information in accordance with the present invention. Referring to FIG. 3A and FIG. 3B one routine of a method for a networked aggregate medical server 50 is generally shown at numeral 200. A patient may input instructions to restrict medical information where the patient node 20 may transmit the instructions over the Internet 60 to the aggregated medical server 50 (Block 210). The aggregated medical server 50 may receive a patient request to restrict medical information and may subsequently authenticate the patient request by verification of the patient's public key or digital certificate with a third party certificate authority (Block 220). In another embodiment, the patient may log on to the medical server 50 using a user ID and a password. The aggregated medical server 50 may then determine if a patient authentication is successful (Block 230). If the patient authentication fails, the medical server 50 may determine to reattempt patient authentication (Block 240). The medical server 50 may make an affirmative determination to repeat the authentication of the patient repeating (Block 220). The medical server 50 may make a negative determination to terminate the patient authentication and routine (Block 250). Subsequent to authenticating the patient request the aggregated medical server 50 may determine if an access table 130 exists (Block 260). Subsequent to an affirmative determination the medical server 50 may update the access table 130 with the patient's instructions (Block 270). The medical server 50 may then terminate the routine (Block 290). If the medical server 50 determines that no access table 130 exists, then the medical server 50 may construct an access table 130 (Block 280). Subsequently, the medical server 50 may terminate the routine (Block 290). In another embodiment, the aggregated medical server 50 may then locate all the patient's medical records and synchronize the encryption of all located files.

A requestor consisting of at least one member of a group containing the patient, health insurer, healthcare provider and an interested third party may request patient medical information. The patient may input a request for patient medical information. This request may be received at the medical server 50 where the patient node 20 may transmit the request via the Internet 60 to the aggregated medical server 50 (Block 300). The health insurer or third party may input a request for patient medical information. This request may be received at the medical server 50 where the health insurer server 30 may transmit the request via the Internet 60 to the aggregated medical server 50 (Block 300). The healthcare provider may input a request for patient medical information. This request may be received at the medical server 50 where the Healthcare provider server 40 may transmit the request via the Internet 60 to the aggregated medical server 50 (Block 300). The aggregated medical server 50 may receive the request for patient medical information and may then authenticate the request by verifying the requestor's public key or digital certificate with a third party certificate authority (Block 310). In another embodiment, the requestor may log on to the medical server 50 using a user ID and password. The aggregate medical server 50 may then determine if a requester authentication is successful (Block 320). If the requestor authentication fails, the aggregate medical server 50 may determine to re-attempt requestor authentication (Block 330). The medical server 50 may make an affirmative determination to repeat the requestor authentication repeating (Block 310). The medical server 50 may make a negative determination to terminate the requestor authentication and routine (Block 340). Subsequent to authenticating the request for medical information, the aggregated medical server 50 may correlate the patient table 110, healthcare provider/health insurer table 120, and the access table 130 for authorization levels (Block 350). The medical server 50 may then determine whether to grant or deny access (Block 360). If access is denied, the aggregate medical server 50 may terminate the routine and may communicate the denial to the requestor where the aggregate medical server may transmit the request via the Internet 60 to the healthcare provider server 40 or the health insurer server 30 depending on the originator of the request (Block 390). Subsequent to the granting access, the aggregated medical server 50 may then encrypt and transmit the designated portion of the patient medical records to the requester (Block 370). The aggregated medical server 50 may then terminate the operation (Block 380).

In another embodiment the aggregated medical server 50 may then transfer a copy of the encrypted portion of the record to a secure URL for the requestor to access (Block 400). The aggregated medical server 50 may then transmit the secure URL to the requester where the aggregated medical server 50 may transmit the URL via the Internet 60 to the patient node 20, the healthcare provider server 40 or the health insurer server 30 depending on the originator of the request (Block 410). The aggregated medical server 50 may then terminate the routine (Block 420).

The aggregate medical server 50 may distribute any of the operations described in the routine generally shown in FIG. 3A and FIG. 3B at numeral 200 to a health insurer server 30 and a healthcare provider server 40. The medical server 50 may coordinate the operations of the health insurer server 30 and healthcare provider server 40 over the Internet 60, necessary to execute the routine. The medical server 50 may delegate implementation of any feature shown in the routine to the health insurer server 30 and healthcare provider server 40. The medical server 50 may assign a hierarchical rank to the distributed servers performing the routine operations.

While the embodiments of the invention disclosed herein are presently considered to be preferred, various changes and modifications may be made without departing from the spirit and scope of the invention. The scope of the invention is indicated in the appended claims, and all changes that come within the meaning and range of equivalents are intended to be embraced therein.

1. A method of providing patient medical financial information through a networked connection comprising:
receiving a patient medical financial information at an aggregate medical server;
receiving patient access instructions at the aggregate medical server;
receiving an access request from a requester at the aggregate medical server;
determining whether the access request corresponds with the patient access instructions;
formatting the patient medical financial information into a requester readable data format; and
sending a portion of the formatted patient medical financial information to the requestor based on the patient access instructions and the access request, if the patient access instructions correspond with the patient access request.

2. The method of claim 1 further comprising:
sending the medical financial information to an insurance server;
receiving modified medical financial information from the insurance server at the aggregate medical server; and
formatting the modified medical financial information.

3. The method of claim 2 wherein the modified medical financial information comprises members selected from a group consisting of:
an insurance payment, a patient co-payment, portions of a patient medical charge, an allowed medical charge, a discount applied and the amount due by a patient of the patient medical charge.

4. The method of claim 1 wherein the requestor is selected from a group consisting of a patient and a third party authorized by the patient to request patient medical financial information.

5. The method of claim 1 wherein the requestor readable data format comprises a patient readable format.

6. The method of claim 5 wherein the patient readable format comprises a PC based home financial program from a group consisting of Quicken®, TurboTax®, MS Money®, Peachtree Accounting® and QuickBooks®.

7. The method of claim 1 further comprising:
an agent in communication with the aggregate medical server, wherein the agent software is capable of providing tax related information based on patient medical financial information received at the agent.

8. The method of claim 7 wherein the agent resides at a patient PC.

9. The method of claim 7 wherein the agent resides on the medical aggregate server.

10. The method of claim 1 further comprising:
providing a hyperlink to the aggregate server wherein the hyperlink comprises the access request.

11. The method of claim 10 wherein the hyperlink is provided on a web site for access by the requestor.

12. The method of claim 1 wherein determining whether the access request corresponds with the patient access instructions further comprises implementing at least one security feature.

13. The method of claim 12 wherein the security feature is selected from a group consisting of a user password, a public key cryptograph, a digital signature, and an XML based security standard.

14. The method of claim 1 further comprising:
verifying a portion of the patient medical financial information with an outside server.

15. The method of claim 14 wherein verifying the portion of the patient medical financial information comprises determining a patient eligibility.

16. The method of claim 1 further comprising:
updating the patient medical financial information.

17. The method of claim 1 wherein the patient medical financial information is selected from a group consisting of a name, a social security number, a plan number, personal information, medical history information, medical claims information, prescription information, insurance company information, billing information, and health provider information.

18. The method of claim 1 wherein the access information comprises level authorization information.

19. A computer usable medium including a program for controlling access to patient medical financial information through a networked connection comprising:
computer readable program code for receiving a patient medical financial information at an aggregate medical server;
computer readable program code for receiving patient access instructions at the aggregate medical server;
computer readable program code for receiving an access request from a requester at the aggregate medical server;
computer readable program code for determining whether the access request corresponds with the patient access instructions;
computer readable program code for formatting the patient medical financial information into a requester readable data format; and
computer readable program code for sending a portion of the patient medical financial information to the requestor based on the patient access instructions and the access request if the patient access instructions corresponds with the access request.

20. The computer usable medium of claim 19 further comprising:
computer readable code for sending the medical financial information to an insurance server;
computer readable code for receiving modified medical financial information from the insurance server; and
computer readable code for formatting the modified medical financial information.

21. The computer usable medium of claim 20 wherein the medical financial data comprises selected members of a group consisting of a payment, a patient co-payment portions of a patient medical charge, an allowed medical charge, a discount applied and an amount due by a patient of the patient medical charge.

22. The computer usable medium of claim 21 wherein the requestor readable data format comprises a patient readable format.

23. The computer usable medium of claim 19 wherein the patient readable format comprises a PC based home financial program from a group consisting of Quicken®, TurboTax®, MS Money®, Peachtree Accounting® and QuickBooks®.

24. The computer usable medium of claim 19 further comprising:
computer readable code for consolidating patient financial information at an agent software.

25. The computer usable medium of claim 24 wherein the agent software calculates a tax credit based on the patient medical financial information.

26. The computer usable medium of claim 19 further comprising:
computer readable code for providing a hyperlink to the aggregate server wherein the hyperlink comprises the access request.

27. The computer usable medium of claim 26 wherein the hyperlink is provided on a web site for access by the requestor.

28. The computer usable medium of claim 19 wherein the computer readable code for determining whether the access request corresponds with the patient access instructions comprises computer readable code for implementing security features.

29. The computer usable medium of claim 28 wherein the security feature is selected from a group consisting of a user password, a public key cryptograph, a digital signature, and an XML based security standard.

30. The computer usable medium of claim 19 further comprising:
computer readable code for verifying a portion of the patient medical financial information with an outside server.

31. The computer usable medium of claim 30 wherein the computer readable code for verifying the portion of the patient medical financial information comprises:
computer readable code for determining a patient's eligibility.

32. The computer usable medium of claim 19 further comprising:
computer readable code for updating the patient medical financial information.

33. The computer usable medium of claim 19 wherein the patient medical financial information is selected from a group consisting of a name, a social security number, a plan number, personal information, medical history information, medical claims information, prescription information, insurance company information, billing information, and health provider information.

34. The computer usable medium of claim 19 wherein the access information comprises level authorization information.

35. A system to provide patient medical financial information through a networked connection comprising:
means for receiving a patient medical financial information at an aggregate medical server;
means for receiving patient access instructions at the aggregate medical server;
means for receiving a request from a requester at the aggregate medical server;
means for determining whether the access request corresponds with the patient access instructions;
means for formatting the patient medical financial information into a requestor readable data format; and
means for sending a portion of the patient medical financial information to the requestor based on the access instructions and the access request if the patient access instructions corresponds with the access request.
